(19) United States
(12) Patent Application Publication
(10) Pub. No.: US 2013/0174145 A1
(43) Pub. Date: Jul. 4, 2013

(54) VIRTUAL RESOURCES MANAGEMENT METHODS

(71) Applicants: Ming-Chiang CHEN, (US); Kun-Yuan Hsieh, (US)

(72) Inventors: Ming-Chiang CHEN, (US); Kun-Yuan Hsieh, (US)

(21) Appl. No.: 13/339,115

(22) Filed: Dec. 28, 2011

(51) Int. Cl. G06F 9/455

(52) U.S. Cl. 718/1

(57) ABSTRACT

A virtual resources management method for a plurality of physical machines, includes: obtaining temperature values for the physical machines respectively; determining whether the temperature value exceeds a threshold value; categorizing the physical machines having temperature values exceeding the threshold value as an overheating group; selecting one of the physical machines as a candidate physical machine; determining whether the candidate physical machine belongs to the overheating group, wherein the virtual machine is assigned to the candidate physical machine when the candidate physical machine does not belong to the overheating group, and the virtual machine is assigned to one of the physical machines other than the candidate physical machine when the candidate physical machine belongs to the overheating group; and performing the virtual machine by the physical machine that is assigned the virtual machine.

### BACKGROUND

1. Technical Field

The disclosure relates generally to methods for virtual resources management, and more particularly relates to virtual resources management with thermal issues.

2. Description of the Related Art

Virtualization techniques allow a physical machine such as a computer to support concurrent running of more than one operating system. Also, operating systems and associated applications, held in containers called virtual machines, are controlled and scheduled by a hypervisior (or so-called a virtual machine monitor (VMM)). The hypervisior is computer software/hardware platform virtualization software that allows multiple virtual machines to run on a physical machine concurrently. The hypervisior may provide a set of the virtual resources such as a virtual CPU, memory and IO device for applications that run on it. The hypervisior may map portions or all of the physical hardware devices of the host computer into a virtual machine and generate virtual devices contained in the virtual machine.

Nowadays, because of the centralization of these physical machines in a data center, lots of physical machines such as host servers are arranged in a relatively small physical space, such that heat management and thermal efficiency of such data center has become a significant issue. When a high temperature occurs in the center, the failure rate of the physical machines therein may increase. For example, every 10° C. increase of temperature leads to a doubling of the failure rates of the physical machines. Also, when the hot air and cold air are mixed, the complex airflow may generate a hot spot such that the risk of the physical machines being damaged is increased. Further, in the conventional art, a cooling system is usually utilized to solve the problems. However, it is seldom considered, that problems may occur due to the defects or operation failure of the cooling system.

### SUMMARY

In an embodiment of a virtual resources management method, for a plurality of physical machines, wherein at least one of the physical machines perform at least one of virtual machines, comprising: obtaining a temperature value for each of the physical machines; determining whether the temperature value of each of the physical machines exceeds a threshold temperature value; categorizing the physical machines which have the temperature value exceeding the threshold temperature value as an overheating group; selecting one of the physical machines as a candidate physical machine; determining whether the candidate physical machine belongs to the overheating group; assigning the virtual machine to one of the physical machines, wherein the virtual machine is assigned to the candidate physical machine when the candidate physical machine does not belong to the overheating group, and the virtual machine is assigned to one of the physical machines other than the candidate physical machine when the candidate physical machine belongs to the overheating group; and performing the virtual machine by the physical machine that is assigned the virtual machine.

In an embodiment of a virtual resources management method, for a plurality of physical machines, wherein at least one of the physical machines perform at least one of virtual machines, comprising: obtaining a temperature value for each of the physical machines; determining whether the temperature value of each of the physical machines exceeds a threshold temperature value; categorizing the physical machines which have the temperature value exceeding the threshold temperature value as an overheating group; migrating all of the virtual machines from the physical machines of the overheating group to the physical machines of a normal group; and performing the migrated virtual machines by the physical machines of the normal group.

In an embodiment of a virtual resources management method, for a plurality of physical machines, wherein each of the physical machines perform a plurality of virtual machines, and the physical machines are grouped into a plurality of physical machine sets, wherein each of the physical machines in a same physical machine set share a cooling system, comprising: obtaining a temperature value for each of the physical machines; determining whether the temperature value of each of the physical machines exceeds a threshold temperature value; setting an operation mode as one of a first mode, a second mode and a third mode according to a number of the physical machines with the temperature value exceeding the threshold temperature value; migrating all of the virtual machines from the physical machines of the overheating group to the physical machines of the normal group; and performing the migrated virtual machines by the physical machines of the normal group, wherein when the operation mode is set as the first mode, the physical machines with the temperature value exceeding the threshold temperature value are categorized as an overheating group, and the physical machines with the temperature value not exceeding the threshold temperature value are categorized as a normal group; when the operation mode is set as the second mode, the physical machines with the temperature value exceeding the threshold temperature value are categorized as the overheating group, and the physical machine set having no the physical machine with the temperature value exceeding the threshold temperature value are categorized as the normal group; and when the operation mode is set as the third mode, the physical machine set having the physical machine with the temperature value exceeding the threshold temperature value are categorized as the overheating group, and the physical machine set having no the physical machine with the temperature value exceeding the threshold temperature value are categorized as the normal group.

### BRIEF DESCRIPTION OF DRAWINGS

The disclosure will become more fully understood by referring to the following detailed description with reference to the accompanying drawings, wherein:

FIG. 1 is schematic diagrams illustrating an embodiment of physical machines in a data center;

FIG. 2A is a flowchart of an embodiment of a virtual resources management method for categorizing the physical machines;

FIG. 2B is a flowchart of an embodiment of a virtual resources management method for placing an added virtual machine;

FIG. 3A is schematic diagrams illustrating an embodiment of physical machines in a data center with the block of overheating physical machines shaded;

FIG. 3B is schematic diagrams illustrating an embodiment of physical machines in a data center;

FIG. 4 is a flowchart of an embodiment of a virtual resources management method for managing virtual machines dynamically;

FIGS. 5A and 5B are a flowchart of another embodiment of a virtual resources management method for managing virtual machines dynamically; and

FIGS. 6A-6C are schematic diagrams illustrating an embodiment of physical machines of a data center in different cases.

### DETAILED DESCRIPTION

The making and using of the embodiments of the present disclosure are discussed in detail below. It should be appreciated, however, that the embodiments provide many applicable inventive concepts that can be embodied in a wide variety of specific contexts. The specific embodiments discussed are merely illustrative of specific ways to make and use the disclosure, and do not limit the scope of the disclosure.

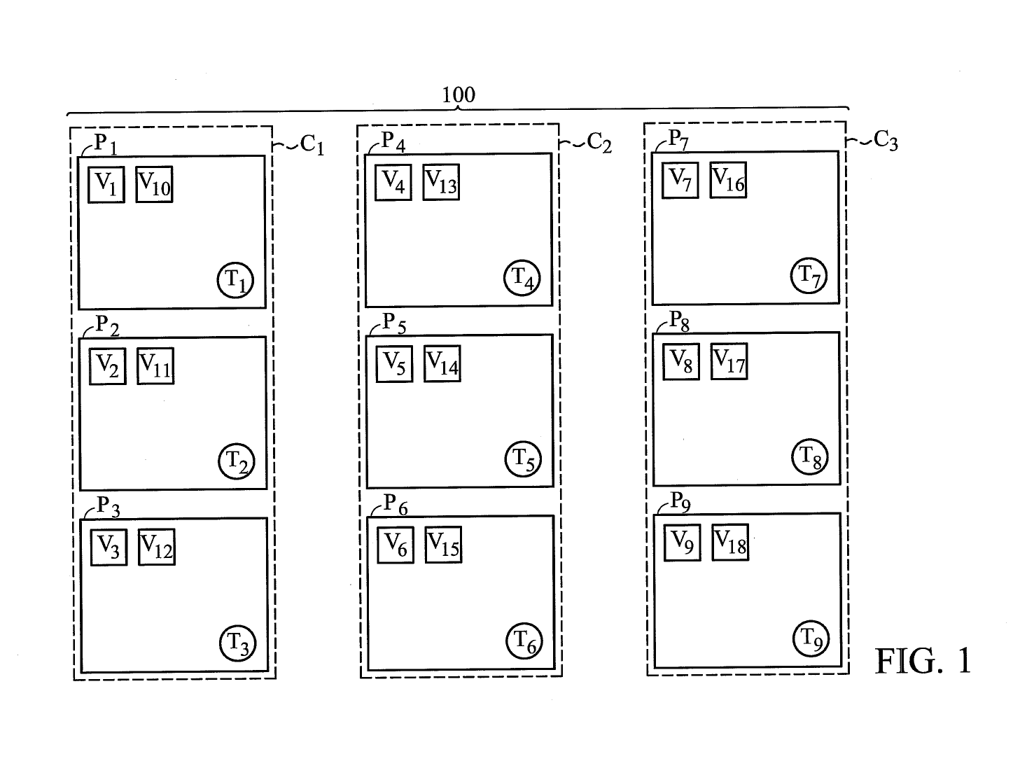

FIG. 1 is a schematic diagram illustrating an embodiment of physical machines in a data center 100. In the embodiment, there are usually lots of the physical machines (such as computers) in a data center, each physical machine may perform one or more virtual machines, and parts of the physical machines share a cooling system (such as cooling fans, heat sinks, heat pipes, etc.). In order to simplify the description, a data center having nine physical machines is used, for example, in the following, wherein each perform two virtual machines as shown in FIG. 1.

FIG. 1 shows an embodiment of a data center 100, wherein there are nine physical machines P1-P9 within the data center 100, the physical machines P1-P9 perform eighteen virtual machines (V1-V18), the physical machines P1-P3 share a cooling system C1, the physical machines P4-P6 share a cooling system C2, and the physical machines P7-P9 share a cooling system C3. Also, the physical machines sharing the same cooling system are formed as a physical machine set. Specifically, the physical machines P1-P3, the physical machines P4-P6, and the physical machines P7-P9 form a physical machine set respectively. The physical machines P1-P9 are controlled by a service node (not shown), and the service node controls the placing and migrating of the virtual machines to each physical machine. It is to be understood that the number of the physical machines, the number of the virtual machines and the arrangement in FIG. 1 are only for example, and the disclosure is not limited thereto.

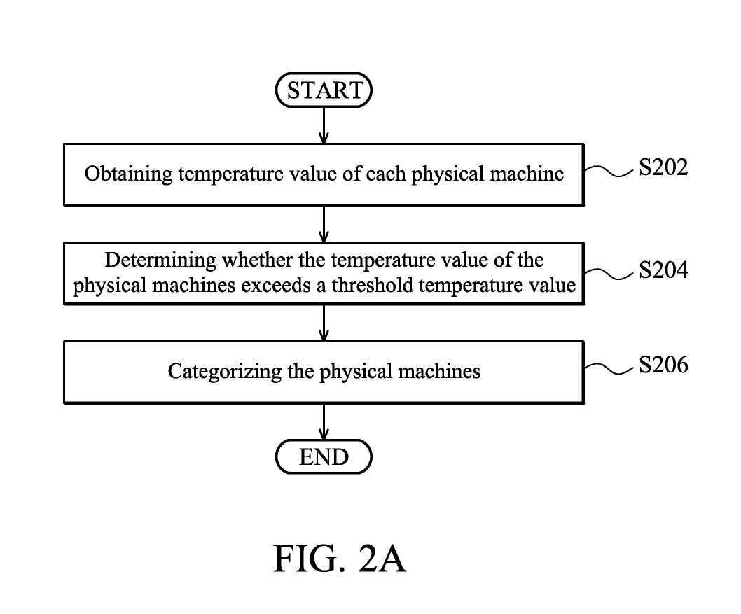

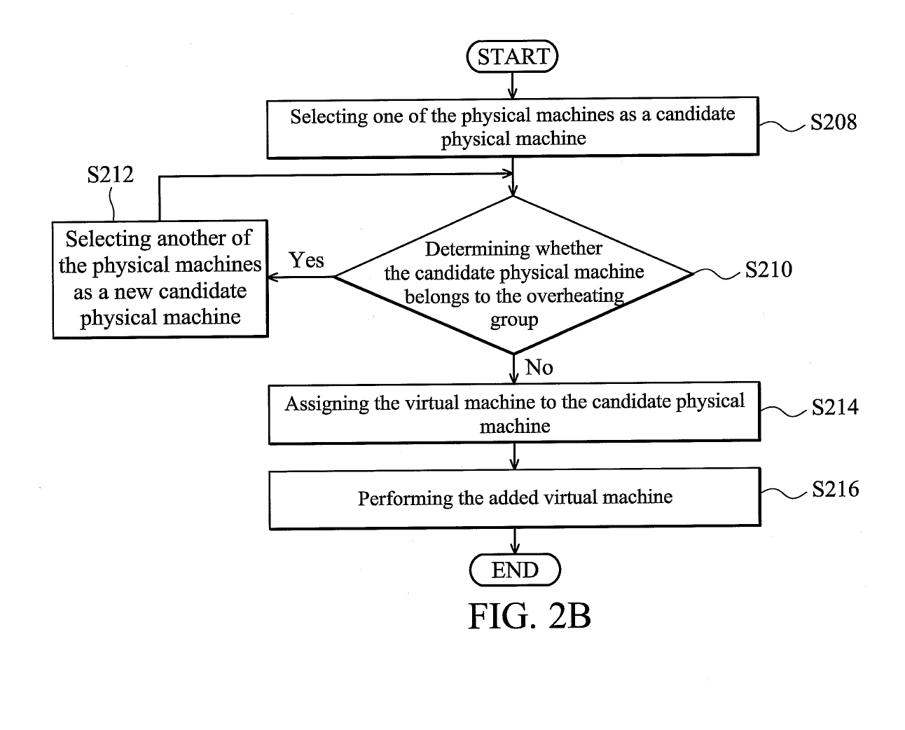

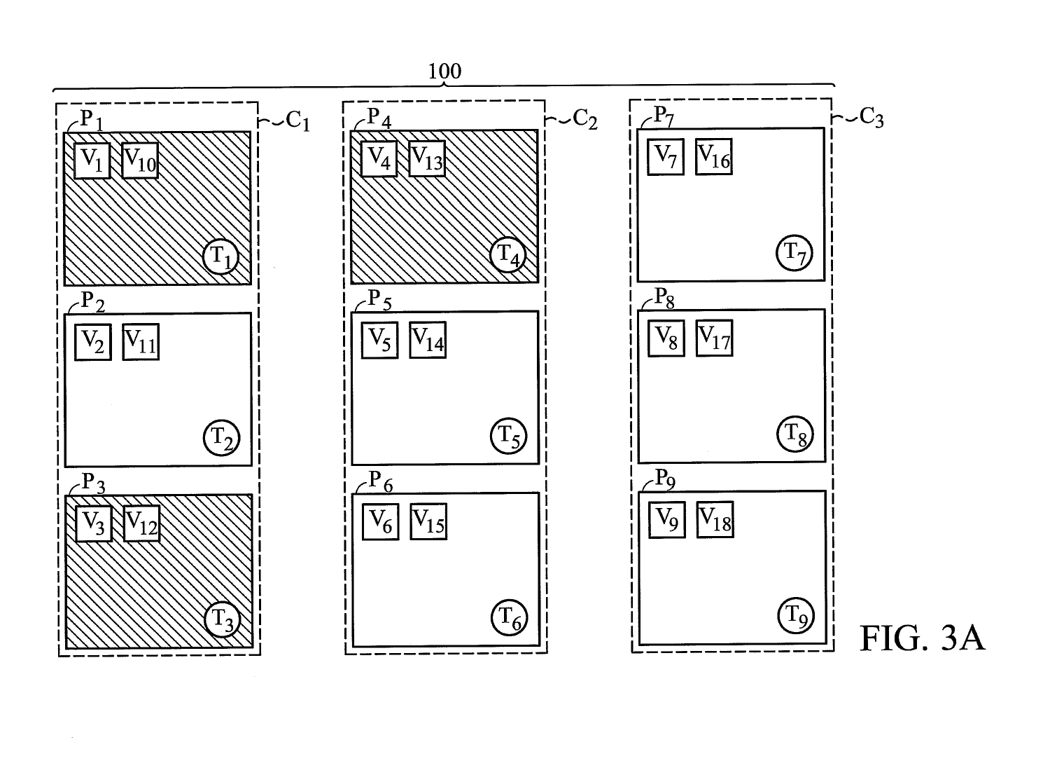

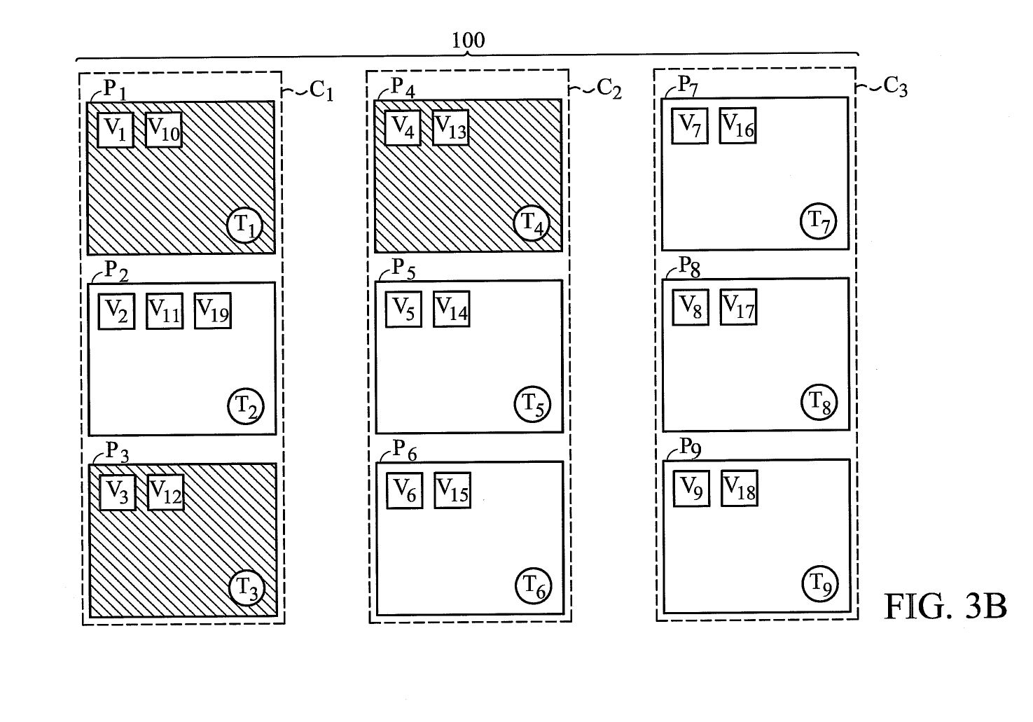

FIGS. 2A-2B are flowcharts of an embodiment of a virtual resources management method for managing virtual machines statically, wherein FIG. 2A is a flowchart of an embodiment of a virtual resources management method for categorizing the physical machines. In step S202, the service node obtains a temperature value of each physical machine. This may be performed by each temperature sensor of each physical machine. In step S204, the service node determines whether the temperature values of the physical machines exceeds a threshold temperature value during a predetermined period, such that the physical machines, having the temperature value exceeding the threshold temperature value, may be identified by the service node. Also, the predetermined period is set for ensuring that the temperature does indeed exceed the threshold temperature. For example as shown in FIG. 1, it is assumed that the physical machines P1, P3, and P4 respectively have the temperature values T1, T3 and T4 exceeding the threshold temperature value, accordingly, the service node may identify the physical machines P1, P3, and P4 as “HOT”. In addition, for easy recognition, the blocks of the physical machines P1, P3, and P4 identified as “HOT” are shaded in FIG. 3A. Note that the threshold temperature may be set according to user requirements or the default value of the spec of the physical machine. In step S206, the physical machines identified as “HOT” are categorized as an overheating group by the service node. For instance in FIG. 3A, the physical machines P1, P3, and P4 are categorized as the overheating group.

In another embodiment, the physical machines sharing the cooling system with the physical machines identified as “HOT” are categorized as the overheating group by the service node. This means that a physical machine set may be categorized as the overheating group when one of the physical machines of the physical machine set is overheating. For instance as shown in FIG. 3A, the physical machines P1, P2, P3, P4, P5 and P6 would be categorized as the overheating group. This is because the physical machines P2 shares the cooling system C1 with the physical machines P1 and P3 (“HOT”), and the physical machines P5 and P6 share the cooling system C2 with the physical machine P4 (“HOT”).

For the sake of defining the overheating group, before the service node assigns an added virtual machine to a selected physical machine, the service node may determine whether the added virtual machine should be assigned to the selected physical machine. Details for assigning an added virtual machine are described in the following with reference to FIG. 2B.

FIG. 2B is a flowchart of an embodiment of a virtual resources management method for placing an added virtual machine. In step S208, the service node selects one of the physical machines as a candidate physical machine. In step S210, the service node determines whether the candidate physical machine belongs to the overheating group, the process will proceed to step S212 if the candidate physical machine belongs to the overheating group, and the process will proceed to step S214 if the candidate physical machine does not belong to the overheating group.

In step S212, the service node skips the old candidate physical machine and selects another of the physical machines as a new candidate physical machine, and then the process will proceed to step S210. In step S214, the service node assigns the added virtual machine to the candidate physical machine. In step S216, the physical machine being the candidate physical machine performs the added virtual machine.

For example, referring to the embodiment of FIG. 3A, when the service node is going to assign the virtual machine V19 (the added virtual machine) to a selected physical machine, the service node may select the physical machine P1 as a candidate physical machine in step S208. Note that, the selected candidate physical machine may be any one of the physical machines P1-P9, due to user requirements or the default virtual machine placement policy. Next, the service node determines whether the physical machine P1 belongs to the overheating group in step S210. Due to the physical machine P1 being categorized as the overheating group, the process will proceed to step S212. In step S212, the physical machine P2 may be selected as the candidate physical machine in place of the physical machine P1 by the service node. Next, the process will proceed to step S210, and the service node determines whether the physical machine P2 belongs to the overheating group. Due to the physical machine P2 not being categorized as the overheating group, the process will proceed to step S214. In step S214, the service node assigns the virtual machine V19 to the candidate physical machine that is the physical machine P2 now. In step S216, as shown in FIG. 3B, the physical machine P2 performs the virtual machine V19.

Although the service node selects the physical machine P2 as the new candidate physical machine in step S212 for example, it is to be understood that the disclosure is not limited thereto. For instance, the service node may select one of the physical machines P2-P9 as the new candidate physical machine according to other considerations such as the work loading of each physical machine. However, due to the physical machine P1, P3 and P4 belonging to the overheating group in the case of FIG. 3A, the physical machine P1, P3 and P4 are always skipped, such that the physical machines P1, P3 and P4 would not be placed any added virtual machine. Accordingly, the process proceeds to step S212 unless the selected candidate physical machine does not belong to the overheating group, such that only the physical machines P2, P5, P6, P7, P8 and P9 may be assigned the added virtual machine by the service node, and then the assigned physical machine would performs the virtual machine V19 in step S216. Thus, the disclosure minimizes damage from the physical machines overheating, and reduces the risk of occurrence of the thermal imbalance in the data center.

In addition, because the service node may further categorize the physical machines sharing the cooling system with the “hot” physical machines identified as the overheating group in some embodiments, the physical machines P1, P2, P3, P4, P5 and P6 are categorized as the overheating group. In this embodiment, in step S214, only the physical machine P7, P8 and P9 may be assigned the added virtual machine by the service node accordingly. Due to the overheating may be caused by the failed cooling system, the thermal imbalance and failure rates of the physical machine of a data center could decrease largely by this advanced categorizing.

In some embodiments, the service node may establish an available list for selecting a physical machine, wherein the available list comprises the physical machines except for the physical machines belonging to the overheating group, and the service node may assign the new virtual machine to one of the physical machines from the available list directly. Also, it is to be understood that although the process shown in FIG. 2B is operated, the process shown in FIG. 2A may keep operating such that the temperature of the physical machines may be monitored in real time.

The embodiments described above show the management of placing an added virtual machine to one of the physical machines. In the following descriptions, the virtual machines having been placed in the physical machines are further controlled.

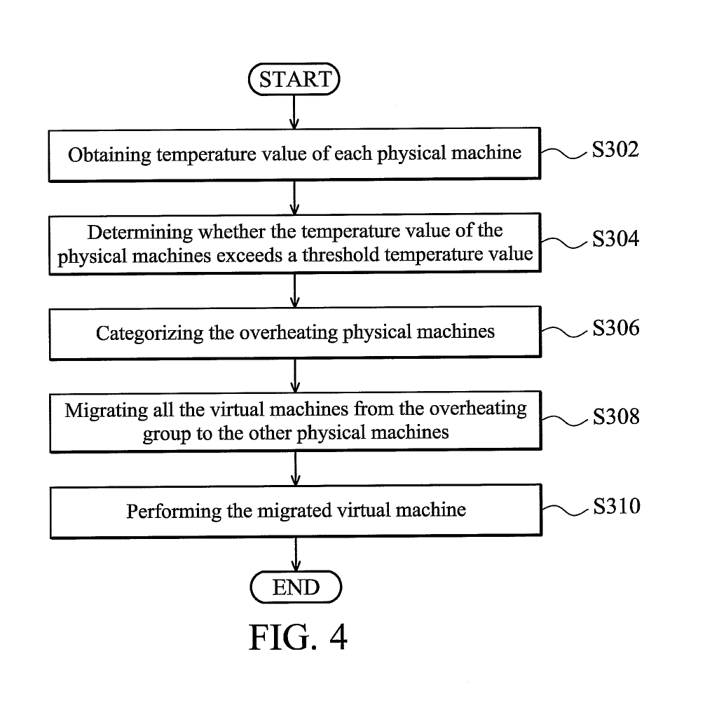

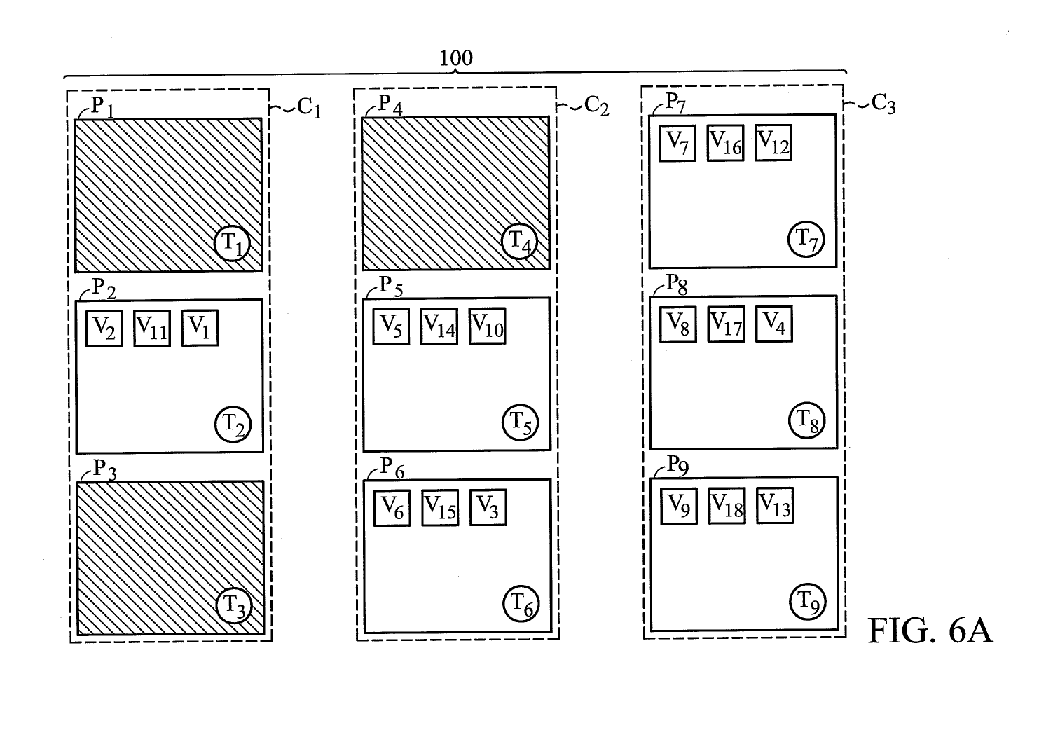

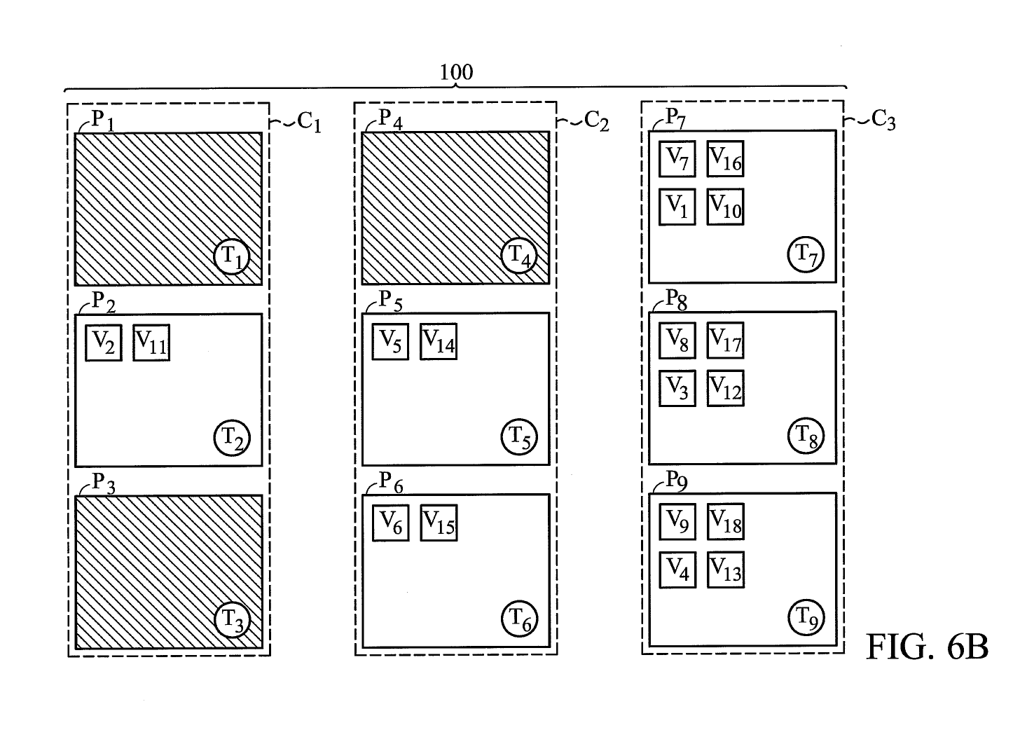

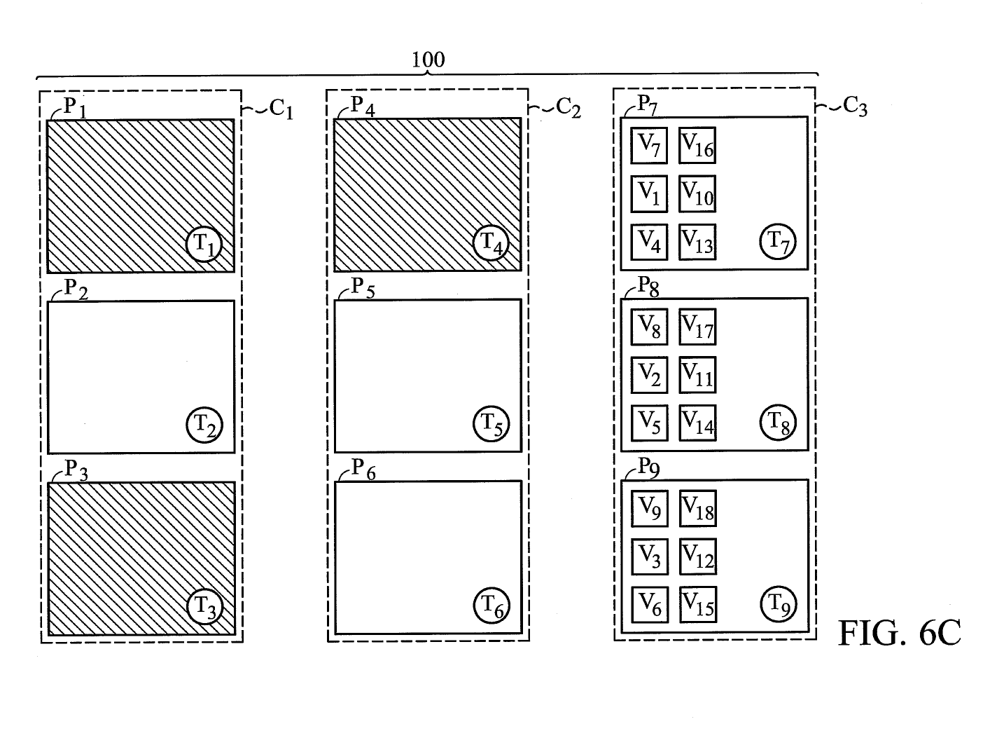

FIG. 4 is a flowchart of an embodiment of a virtual resources management method for managing virtual machines dynamically. In step S302, the service node obtains a temperature value of each physical machine. In step S304, the service node determines whether the temperature values of the physical machines exceeds a threshold temperature value, such that the physical machines, having the temperature value exceeding the threshold temperature value, may be identified by the service node. In step S306, the physical machines, having the temperature value exceeding the threshold temperature value, are categorized as an overheating group by the service node. In step S308, the service node migrates all of the virtual machines from the physical machines of the overheating group to the physical machines not belonging to the overheating group. In the case of FIG. 3A, each of the virtual machines V1, V10, V3, V12, V4 and V13 would be migrated to the physical machines P2, P5, P6, P7, P8 and P9. Generally speaking, in order to disperse the work loading, the virtual machines V1, V10, V3, V12, V4, V13 would be migrated to each of the physical machines P2, P5, P6, P7, P8 and P9 evenly as shown in FIG. 6A. Note that the example in FIG. 6A merely shows a preferred embodiment, the virtual machines V1, V10, V3, V12, V4, V13 may be migrated to one or parts of the physical machines P2, P5, P6, P7, P8 and P9 depending on user design. Also, the order of migrating the virtual machines or the destination of each the migrated virtual machine both are designed according the usage requirements; thus, the disclosure is not limited thereto.

Finally, in step 5310, the virtual machines which were performed by the overheating physical machine may be performed in the other virtual machines. Thus, the temperatures of the overheating physical machines may decrease, such that damage of the physical machines is reduced.

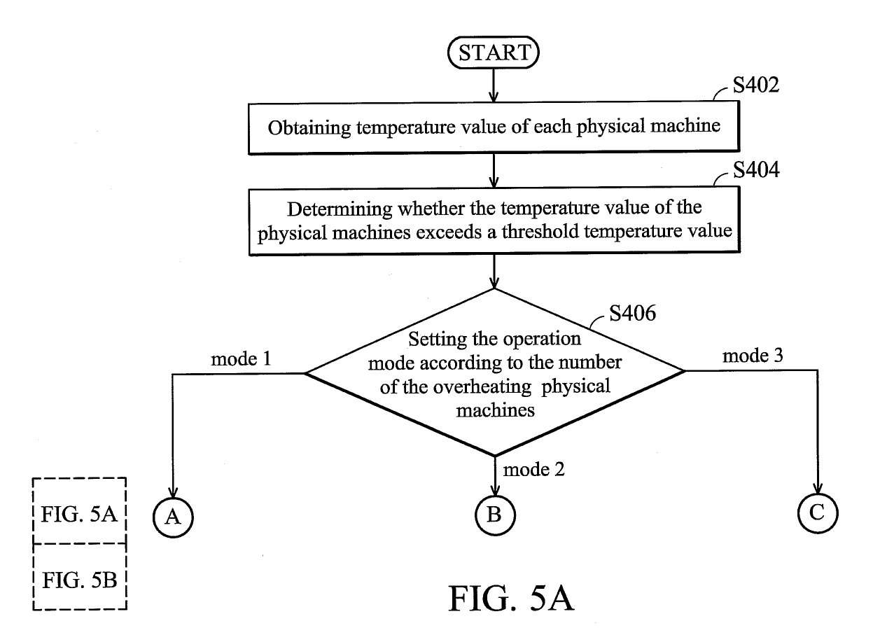

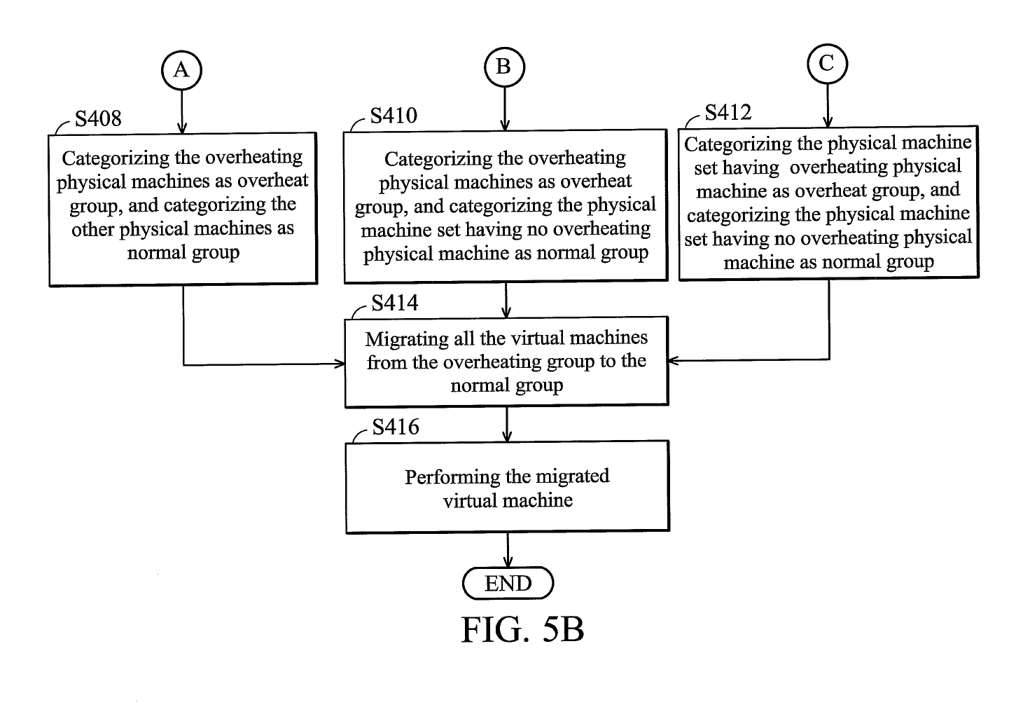

FIGS. 5A-5B are a flowchart of a preferred embodiment of a virtual resources management method for managing virtual machines dynamically. In this embodiment, the number of overheating physical machines is further considered. Thus, the service node may migrate the virtual machines according to the seriousness of overheating.

In step S402, the service node obtains a temperature value of each physical machine. In step S404, the service node determines whether the temperature values of the physical machines exceeds a threshold temperature value, such that the physical machines, having the temperature value exceeding the threshold temperature value, may be identified by the service node. In step S406, the service node obtains the number of the physical machines with the temperature value exceeding the threshold temperature value, and sets an operation mode as one of a first mode, a second mode and a third mode according to the number. For example, the service node may further calculate an overheating ratio of the number of the physical machines with the temperature value exceeds the threshold temperature value to a number of all of the physical machines. For example, the overheating ratio is 3/9 in the case of FIG. 3A. The operation mode is set as the mode 1 when the overheating ratio is lower than a first predetermined ratio, and the process proceeds to the step S408. The operation mode is set as the mode 2 when the overheating ratio is higher than the first predetermined ratio and is lower than a second predetermined ratio, and the process proceeds to the step S410. The operation mode is set as the mode 3 when the overheating ratio is higher than the second predetermined ratio, and the process proceeds to the step S412. Note that the first predetermined ratio and the second predetermined ratio may be set according to user requirements. In another embodiment, the service node may calculate the overheating ratio of the number of the physical machines with a temperature value exceeding the threshold temperature value (P1, P3 and P4) to a number of the physical machines sharing the cooling machine with the overheating physical machine (P1-P6). For example the overheating ratio is 3/6 in the case of FIG. 3A.

In step S408, namely in the mode 1, the physical machines with the temperature value exceeding the threshold temperature value are categorized as an overheating group, and the physical machines with the temperature value not exceeding the threshold temperature value are categorized as a normal group. For example, as FIG. 3A shows, if the overheating ratio (3/9) is lower than the first predetermined ratio, the physical machines P1, P3 and P4 are categorized as the overheating group, and the physical machines P2, P5, P6, P7, P8 and P9 are categorized as the normal group. In this case, in the following step S414, each of the virtual machines V1, V10, V3, V12, V4, V13 would be migrated to the physical machines P2, P5, P6, P7, P8 and P9, as shown in FIG. 6A.

In step S410, namely in the mode 2, the physical machines with the temperature value exceeding the threshold temperature value are categorized as the overheating group, and the physical machine set (the physical machines sharing the same cooling system) having no physical machine with the temperature value exceeding the threshold temperature value are categorized as the normal group. For example, as FIG. 3A shows, if the overheating ratio (3/9) is higher than the first predetermined ratio and lower than the second predetermined ratio, the physical machines P1, P3 and P4 are categorized as the overheating group. Note that this part is the same as the mode 1. However, only the physical machines P7, P8 and P9 are categorized as the normal group in the mode 2. This is due to the physical machine P2 shares the cooling system C1 with the physical machines P1 and P3. This means that the physical machine set (P1, P2, P3) has two physical machines (P1, P3) with a temperature value exceeding the threshold temperature. Thus, all of the physical machines of the physical machine set (P1, P2, P3) would not be categorized as the normal group in the mode 2. Also, the physical machines P5 and P6 share the cooling system C2 with the physical machine P4. This means that the physical machine set (P4, P5, P6) has a physical machine (P4) with a temperature value exceeding the threshold temperature. Thus, all of the physical machines of the physical machine set (P4, P5, P6) would not be categorized as the normal group in the mode 2. In this case, in the following step S414, each of the virtual machines V1, V10, V3, V12, V4 and V13 would be migrated to the physical machines P7, P8 and P9, as shown in FIG. 6B.

In step S412, namely in mode 3, the physical machine set has the physical machine with a temperature value exceeding the threshold temperature value are categorized as the overheating group, and the physical machine set has no physical machine with a temperature value exceeding the threshold temperature value are categorized as the normal group. For example, as FIG. 3A shows, if the overheating ratio (3/9) is higher than the second predetermined ratio, not only the physical machines P1, P3 and P4 are categorized as the overheating group, but also the physical machines P2, P5 and P6 are categorized as the overheating group. This is due to the physical machine P2 sharing the cooling system C1 with the physical machines P1 and P3, and the physical machines P5 and P6 sharing the cooling system C2 with the physical machine P4. Note that the physical machines P7, P8 and P9 being categorized as the normal group is the same as the normal group in the mode 2. In this case, in the following step S414, each of the virtual machines V1, V10, V2, V11, V3, V12, V4, V13, V5, V14, V6 and V15 from the physical machine set (P1-P3) and (P4-6) would be migrated to the physical machines P7, P8 and P9, as shown in FIG. 6C.

In step S414, the service node migrates all of the virtual machines from the physical machines of the overheating group to the physical machines of the normal group. Next, in step 5416, the virtual machines which were performed by the overheating physical machine are performed in the other virtual machines. Note that the examples in FIGS. 6A-6C merely show a possible situation in step S414, and the order of migrating the virtual machines or the destination of each of the migrated virtual machines both are designed according the user requirements, such that the disclosure is not limited thereto. The disclosure migrates all virtual machines from the overheating physical machines to other physical machines, and even the virtual machines of the physical machines sharing the cooling system with the overheating physical machines are also migrated, such that damage from overheating physical machines is minimized, reducing the risk of occurrence of the thermal imbalance in the data center effectively, even if it is caused by the defects or operation failure of the cooling system.

Those who are skilled in this technology can still process deletion, addition, or change the order of the steps described above without departing from the scope and spirit of this disclosure. While the disclosure has been described by way of example and in terms of preferred embodiment, it is to be understood that the disclosure is not limited thereto. Those who are skilled in this technology can still make various alterations and modifications without departing from the scope and spirit of this disclosure. Therefore, the scope of the present disclosure shall be defined and protected by the following claims and their equivalents.

What is claimed is:

1. A virtual resources management method, for a plurality of physical machines, wherein at least one of the physical machines perform at least one of virtual machines, comprising:
obtaining a temperature value for each of the physical machines;
determining whether the temperature value of each of the physical machines exceeds a threshold temperature value;
categorizing the physical machines which have the temperature value exceeding the threshold temperature value as an overheating group;
selecting one of the physical machines as a candidate physical machine;
determining whether the candidate physical machine belongs to the overheating group;
assigning the virtual machine to one of the physical machines, wherein the virtual machine is assigned to the candidate physical machine when the candidate physical machine does not belong to the overheating group, and the virtual machine is assigned to one of the physical machines other than the candidate physical machine when the candidate physical machine belongs to the overheating group; and
performing the virtual machine by the physical machine that is assigned the virtual machine.

2. The virtual resources management method of claim 1, wherein the physical machines are grouped into a plurality of physical machine sets, each of the physical machines in the same physical machine set share a cooling system, and the virtual resources management method further comprises categorizing the physical machine set having the physical machine with the temperature value exceeding the threshold temperature value as the overheating group.

3. The virtual resources management method of claim 1, wherein the physical machines of the overheating group have the temperature value exceed the threshold temperature value during a predetermined period.

4. A virtual resources management method, for a plurality of physical machines, wherein at least one of the physical machines perform at least one of virtual machines, comprising:
obtaining a temperature value for each of the physical machines;
determining whether the temperature value of each of the physical machines exceeds a threshold temperature value;
categorizing the physical machines which have the temperature value exceeding the threshold temperature value as an overheating group;
migrating all of the virtual machines from the physical machines of the overheating group to the physical machines of a normal group; and
performing the migrated virtual machines by the physical machines of the normal group.

5. The virtual resources management method of claim 4, wherein the physical machines with the temperature value not exceeding the threshold temperature value are categorized as the normal group.

6. The virtual resources management method of claim 4, wherein the physical machines are grouped into a plurality of physical machine sets, and each of the physical machines in the same physical machine set shares a cooling system, and the physical machine set having no the physical machine with the temperature value exceeding the threshold temperature value are categorized as the normal group.

7. The virtual resources management method of claim 4, wherein the physical machines are grouped into a plurality of physical machine sets, and each of the physical machines in the same physical machine set shares a cooling system, and the physical machine set that has the physical machine with the temperature value exceeding the threshold temperature value are categorized as the overheating group, and the physical machine set that has no the physical machine with the temperature value exceeding the threshold temperature value are categorized as the normal group.

8. The virtual resources management method of claim 4, wherein the physical machines of the overheating group have the temperature value exceed the threshold temperature value during a predetermined period.

9. A virtual resources management method, for a plurality of physical machines, wherein each of the physical machines perform a plurality of virtual machines, and the physical machines are grouped into a plurality of physical machine sets, wherein each of the physical machines in a same physical machine set share a cooling system, comprising:
obtaining a temperature value for each of the physical machines;
determining whether the temperature value of each of the physical machines exceeds a threshold temperature value;
setting an operation mode as one of a first mode, a second mode and a third mode according to a number of the physical machines with the temperature value exceeding the threshold temperature value;
migrating all of the virtual machines from the physical machines of the overheating group to the physical machines of the normal group; and
performing the migrated virtual machines by the physical machines of the normal group,
wherein when the operation mode is set as the first mode, the physical machines with the temperature value exceeding the threshold temperature value are categorized as an overheating group, and the physical machines with the temperature value not exceeding the threshold temperature value are categorized as a normal group;
when the operation mode is set as the second mode, the physical machines with the temperature value exceeding the threshold temperature value are categorized as the overheating group, and the physical machine set having no the physical machine with the temperature value exceeding the threshold temperature value are categorized as the normal group; and
when the operation mode is set as the third mode, the physical machine set having the physical machine with the temperature value exceeding the threshold temperature value are categorized as the overheating group, and the physical machine set having no the physical machine with the temperature value exceeding the threshold temperature value are categorized as the normal group.

10. The virtual resources management method of claim 9, further comprising:
obtaining an overheating ratio of the number of the physical machines with the temperature value exceeds the threshold temperature value to a number of all of the physical machines;
setting the operation mode as the first mode, when the overheating ratio is lower than a first predetermined ratio;
setting the operation mode as the second mode, when the overheating ratio is higher than the first predetermined ratio and lower than a second predetermined ratio; and
setting the operation mode as the third mode, when the overheating ratio is higher than the second predetermined ratio,
wherein the first predetermined ratio is lower than the second predetermined ratio.

11. The virtual resources management method of claim 9, further comprising:
obtaining an overheating ratio of the number of the physical machines with the temperature value exceeds the threshold temperature value to a sharing number, wherein the sharing number is a number of the physical machines that belong to the physical machine set having the physical machine with the temperature value exceeding the threshold temperature value;
setting the operation mode as the first mode, when the overheating ratio is lower than a first predetermined ratio;
setting the operation mode as the second mode, when the overheating ratio is higher than the first predetermined ratio and lower than a second predetermined ratio; and
setting the operation mode as the third mode, when the overheating ratio is higher than the second predetermined ratio, wherein the first predetermined ratio is lower than the second predetermined ratio.

12. The virtual resources management method of claim 9, wherein the physical machines of the overheating group have the temperature value exceed the threshold temperature value during a predetermined period.
